(19) United States
(12) Patent Application Publication
(10) Pub. No.: US 2026/0095641 A1
(43) Pub. Date: Apr. 2, 2026

(54) IMAGE PICKUP APPARATUS CAPABLE OF SUPPRESSING TIME LAG UNTIL PHOTOGRAPHING, CONTROL METHOD FOR IMAGE PICKUP APPARATUS, AND STORAGE MEDIUM

(71) Applicant: CANON KABUSHIKI KAISHA, Tokyo (JP)

(72) Inventor: TAIKI AKAMA, Kanagawa (JP)

(21) Appl. No.: 19/324,540

(22) Filed: Sep. 10, 2025

(30) Foreign Application Priority Data
Oct. 2, 2024 (JP) 2024-173116

(51) Int. Cl. H04N 23/61; H04N 23/67; H04N 23/73; H04N 23/745; H04N 25/443

(52) U.S. Cl. CPC H04N 23/61; H04N 23/672; H04N 23/73; H04N 23/745; H04N 25/443

(57) ABSTRACT

An image pickup apparatus capable of suppressing a time lag until photographing is provided. The image pickup apparatus includes an image sensor including a plurality of pixels, and at least one processor or circuit and a memory storing instructions to cause the at least one processor or circuit to perform operations of a setting unit that sets first photographing conditions in accordance with user's instructions, a detecting unit that detects a characteristic region based on pixel information obtained from the plurality of pixels, and a control unit that causes pixels in the characteristic region among the plurality of pixels to be photographed under second photographing conditions different from the first photographing conditions, and causes pixels in another region other than the characteristic region among the plurality of pixels to be photographed under the first photographing conditions. The detecting unit and the control unit are provided inside of the image sensor.

### BACKGROUND

### Field of the Technology

The present disclosure relates to an image pickup apparatus, a control method for the image pickup apparatus, and a storage medium, and more particularly to an image pickup apparatus that switches pixel control of an image pickup device unit (an image sensor) for each region, a control method for the image pickup apparatus, and a storage medium.

### Description of the Related Art

It has been known that when photographing is performed with respect to a light source that flickers rapidly, such as a light emitting diode light source (an LED light source), with an exposure time that is faster than the flickering, uneven flickering (hereafter, referred to as “flicker”) will occur in the photographed image.

In particular, in recent years, digital signage or the like has become widespread, and if the digital signage is reflected as a part of an image, only a region of the part of the image may be affected by flicker.

It has been known that in order to suppress the influence of the flicker, photographing is performed by adjusting an exposure time to an integer multiple of a flicker frequency. However, this method does not allow a user to perform photographing with an arbitrary exposure time, and subject blurring will occur, for example, in the case of photographing a subject that moves vigorously.

For this reason, in a scene in which digital signage is included in an angle of view, an optimal exposure time for suppressing the flicker may differ from an optimal exposure time for suppressing the subject blurring.

For example, in Japanese Laid-Open Patent Publication (kokai) No. 2023-36384, a method of, in high dynamic range photographing (HDR photographing), dividing pixels, which have been arranged in an array shape on an image pickup device unit (an image sensor), into a short accumulation region and a long accumulation region, and controlling the exposure time for each region has been proposed.

However, in the conventional technique disclosed in Japanese Laid-Open Patent Publication (kokai) No. 2023-36384, it takes time to divide an area (the pixels that have been arranged in an array shape on the image pickup device unit) into the short accumulation region and the long accumulation region, and to control the exposure time for each divided region, resulting in a time lag until photographing.

For this reason, in a scene where a subject moves during a short period of time, such as when the subject is a moving body, this time lag makes it difficult to perform photographing at a desired timing.

### SUMMARY

The present disclosure provides an image pickup apparatus capable of suppressing a time lag until photographing, a control method for the image pickup apparatus, and a storage medium.

Accordingly, an aspect of the present disclosure provides an image pickup apparatus comprising an image sensor configured to include a plurality of pixels, and at least one processor or circuit and a memory storing instructions to cause the at least one processor or circuit to perform operations of the following units, a setting unit that sets first photographing conditions in accordance with instructions from a user, a detecting unit that detects a characteristic region based on pixel information obtained from the plurality of pixels, and a control unit that causes pixels in the characteristic region among the plurality of pixels to be photographed under second photographing conditions different from the first photographing conditions, and causes pixels in another region other than the characteristic region among the plurality of pixels to be photographed under the first photographing conditions. The detecting unit and the control unit are provided inside of the image sensor.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of an image pickup apparatus according to a first embodiment.

FIG. 2A and FIG. 2B are timing charts of obtainment of pixel information for characteristic region detection, the characteristic region detection, and a photographing control according to the first embodiment.

FIG. 3A, FIG. 3B, and FIG. 3C are diagrams that illustrate examples of photographed images in the case where exposure time control has been performed for each region.

FIG. 4 is a flowchart of a flickerless photographing processing according to the first embodiment.

FIG. 5 is a diagram that illustrates a method for setting photographing conditions for each region according to the first embodiment.

FIG. 6A and FIG. 6B are diagrams for explaining HDR photographing according to a second embodiment.

FIG. 7 is a flowchart of an HDR photographing processing according to the second embodiment.

FIG. 8 is a diagram for explaining AF control for each region using a plurality of photodiodes according to a third embodiment.

FIG. 9 is a flowchart of an AF control processing according to the third embodiment.

FIG. 10 is a diagram for explaining resolution-lowered photographing of a region of non-interest according to a fourth embodiment.

### DESCRIPTION OF THE EMBODIMENTS

The present disclosure will now be described in detail below with reference to the accompanying drawings showing embodiments thereof.

Hereinafter, embodiments will be described in detail with reference to the accompanying drawings. It should be noted that the following embodiments do not limit the invention as defined by the claims. Although the embodiments describe a plurality of features, not all of the plurality of features are essential to the present disclosure, and the plurality of features may be combined in any desired manner. Furthermore, in the accompanying drawings, the same or similar configurations (components) are given the same reference numerals, and duplicate descriptions will be omitted.

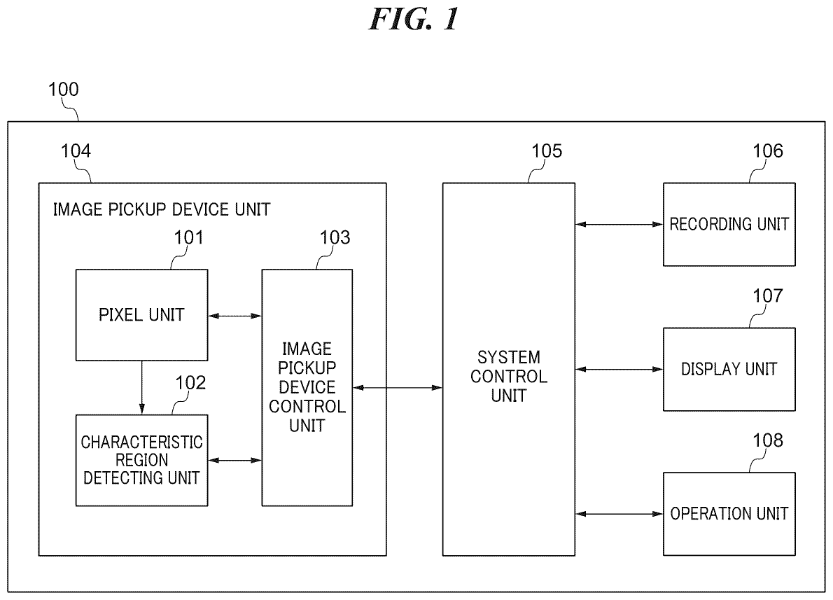

First, a first embodiment will be described. FIG. 1 is a block diagram that illustrates an example of a schematic configuration of an image pickup apparatus 100 according to the first embodiment. The image pickup apparatus 100 according to the first embodiment is, for example, a lens-interchangeable digital camera, to which any lens is capable of being attached, and has a still image pickup function and a moving image pickup function.

As shown in FIG. 1, the image pickup apparatus 100 includes an image pickup device unit 104, a system control unit 105, a recording unit 106, a display unit 107, and an operation unit 108.

The image pickup device unit 104 is, for example, a CMOS image sensor that is configured to include a pixel unit 101, a characteristic region detecting unit 102, and an image pickup device control unit 103.

The pixel unit 101 is configured to include a plurality of pixels, and performs photoelectric conversion with respect to an optical image of a subject at each pixel to generate charges in accordance with the amount of incident light, converts the charges into electrical signals, and generates and outputs digital image data. It should be noted that the image data to be generated here is configured by pixel information from each pixel. At this time, the pixel unit 101 is also capable of amplifying the electrical signals by performing gain control. In addition, the pixel unit 101 also has an electronic shutter function that adjusts the amount of the incident light on each pixel, and is capable of controlling an exposure time.

The characteristic region detecting unit 102 (a detecting unit) detects a characteristic region based on pixel information to be obtained from the pixel unit 101. The characteristic region means a characteristic region within an image area of the image data to be generated by the pixel unit 101, and examples thereof include a flicker region and a subject region.

The image pickup device control unit 103 performs the gain control and exposure time control of the pixel unit 101. In addition, the image pickup device control unit 103 controls a timing and a method of reading out the pixel information from the pixel unit 101.

It should be noted that the image pickup device control unit 103 is capable of, for each region, controlling the exposure time control and the gain control of the pixel unit 101, and the control of reading out the pixel information from the pixel unit 101, respectively, based on the detection result of the characteristic region detecting unit 102.

In addition, the image pickup device control unit 103 outputs, to the system control unit 105, the pixel information that has been obtained from the pixel unit 101.

The system control unit 105 controls the entire image pickup apparatus 100. In addition, the system control unit 105 includes a central processing unit (a CPU), a random access memory (a RAM), and a read only memory (a ROM), all of which are not shown in FIG. 1, that are inside it, and the CPU executes a high-frequency flickerless photographing processing that will be described below by loading a program within the ROM into the RAM and reading it out sequentially, but hereinafter, the main entity executing the high-frequency flickerless photographing processing will simply be the system control unit 105.

The recording unit 106 records image data to be obtained from the image pickup device unit 104, etc.

The display unit 107 performs the display of the image data to be obtained from the image pickup device unit 104, and the display of menus.

The operation unit 108 is used when a user sets photographing conditions and the like.

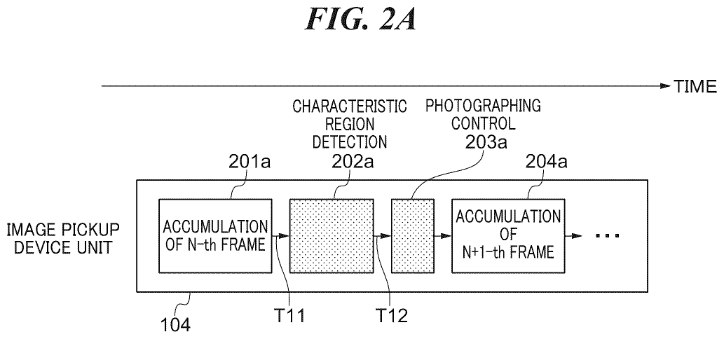

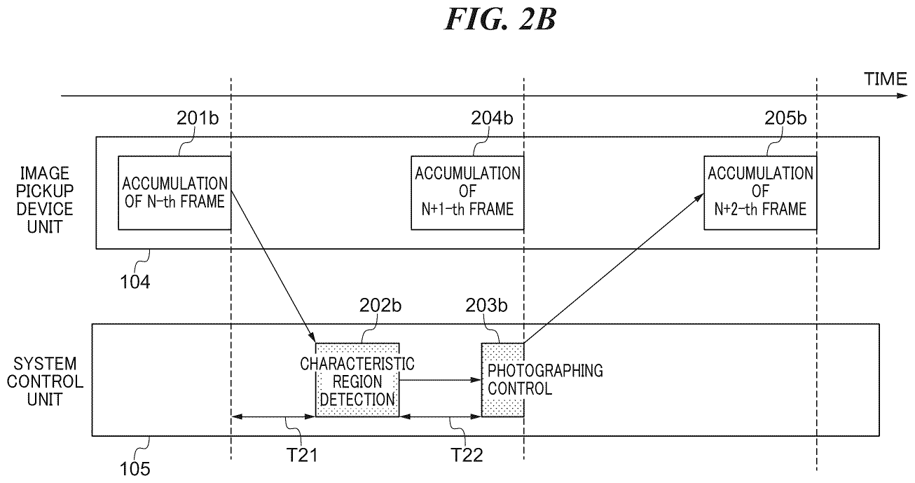

Next, the obtainment of pixel information for characteristic region detection, the characteristic region detection, and a photographing control according to the first embodiment will be described with reference to timing charts that are shown in FIG. 2A and FIG. 2B.

Here, a case will be described in which the obtainment of the pixel information for the characteristic region detection is performed by the accumulation of the N-th frame.

FIG. 2A shows an example of control timings in the case where the characteristic region detecting unit 102 and the image pickup device control unit 103 are included in the inside of the image pickup device unit 104. In the control in this case, since the characteristic region detecting unit 102 that is included in the inside of the image pickup device unit 104 performs the characteristic region detection, there is no need to transfer the pixel information to a characteristic region detecting unit that is included in the outside of the image pickup device unit 104. Therefore, it is possible to instantly perform characteristic region detection 202a by using pixel information that has been obtained by accumulation 201a of the N-th frame. In addition, in the control in this case, the image pickup device control unit 103 that is included in the inside of the image pickup device unit 104 performs a photographing control 203a with respect to the pixel unit 101 on which a characteristic region has been detected by the characteristic region detection 202a. Therefore, there is no need to transfer information about the characteristic region to an image pickup device control unit that is included in the outside of the image pickup device unit 104, and it is possible to perform control such that the result of the characteristic region detection based on the accumulation 201a of the N-th frame is instantly reflected in accumulation 204a of the N+1-th frame.

FIG. 2B shows an example of the control timings in the case where the characteristic region detecting unit 102 and the image pickup device control unit 103 are included in the system control unit 105, which is the outside of the image pickup device unit 104. In the control in this case, a time required to read out pixel information that has been obtained by accumulation 201b of the N-th frame, a time required to transfer the pixel information to the system control unit 105, and so on occur. Therefore, compared with a time lag T11 from the accumulation 201a to performing the characteristic region detection 202a, a time lag T21 from the accumulation 201b to performing characteristic region detection 202b is larger (longer). In addition, the difference between the time lag T11 and the time lag T21 increases as the total number of the pixels included in the pixel unit 101 increases. Furthermore, in the case where the system control unit 105 controls the image pickup device unit 104, for example, restrictions on a periodic photographing control that depend on a frame rate may occur. Therefore, after the characteristic region has been detected, a time lag T22 until a photographing control 203b is started by the system control unit 105 located outside the image pickup device unit 104 is larger (longer) than a time lag T12 until the photographing control 203a inside the image pickup device unit 104 is started.

The above has described the case of FIG. 2A where the characteristic region detection 202a and the photographing control 203a are performed inside the image pickup device unit 104, and the case of FIG. 2B where the characteristic region detection 202b and the photographing control 203b are performed outside the image pickup device unit 104. In the case of FIG. 2B, the time lag from obtaining the pixel information for the characteristic region detection by the accumulation of the N-th frame to detecting a characteristic region and actually performing the photographing control with respect to the detected characteristic region is larger (longer) than that in the case of FIG. 2A. For this reason, in the case of FIG. 2B, the detection result of the N-th frame is not capable of being reflected in accumulation 204b of the N+1-th frame in time, and ends up being reflected in accumulation 205b of the N+2-th frame.

In this way, in the first embodiment, by providing the characteristic region detecting unit 102 and the image pickup device control unit 103 inside the image pickup device unit 104, it is possible to instantly perform the obtainment of the pixel information, the characteristic region detection, and the photographing control for each region. Therefore, compared with the case of FIG. 2B, it is possible to reduce the time lag from the region detection to the photographing control. On the other hand, since the processing load on the image pickup device unit 104 increases, there is a possibility that heat generation from the image pickup device unit 104, which has become an issue in recent years, may further increase. For this reason, a second characteristic region detecting unit may be provided outside the image pickup device unit 104, for example, in the system control unit 105. By adopting such a configuration, depending on the state of the subject and the image pickup device unit 104, the detection of the characteristic region is capable of being switched from the characteristic region detecting unit 102 to the second characteristic region detecting unit, thereby suppressing an increase in the heat generation from the image pickup device unit 104.

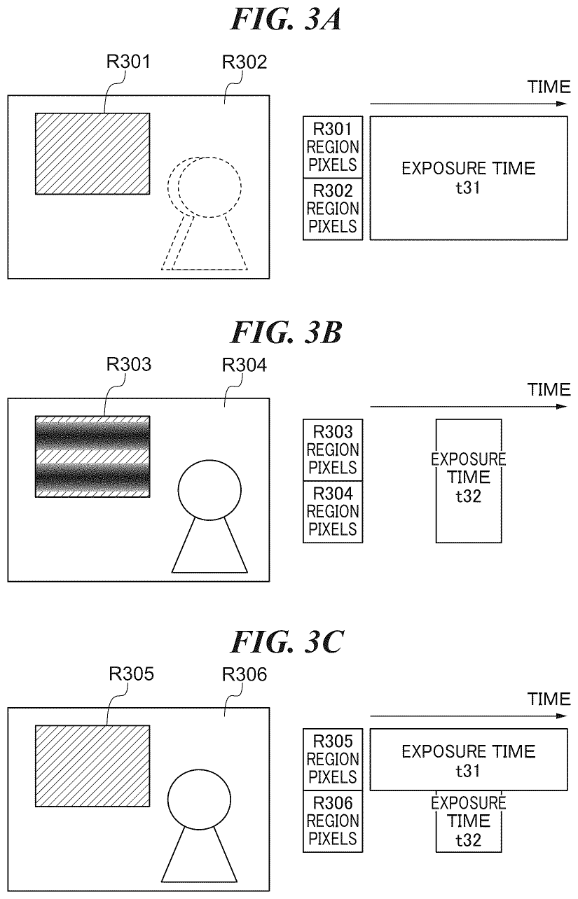

Next, examples of photographed images in the case where the exposure time control has been performed for each region will be illustrated with reference to FIG. 3A, FIG. 3B, and FIG. 3C. In the first embodiment, flickerless photographing will be described.

Flicker regions R301, R303, and R305 represent regions (flicker regions: characteristic regions) where flicker occurs in the respective photographed images that are shown in FIG. 3A, FIG. 3B, and FIG. 3C within an area of the pixel unit 101. On the other hand, normal regions R302, R304, and R306 represent regions (regions other than the characteristic regions) where flicker does not occur in the respective photographed images that are shown in FIG. 3A, FIG. 3B, and FIG. 3C within the area of the pixel unit 101. In addition, the diagram on the right side of each photographed image indicates an exposure time for each region of the pixel unit 101. Hereinafter, the flicker regions R301, R303, and R305 will be described as the characteristic regions.

Here, the examples will be described in which scenes where the flicker regions R301, R303, and R305 each show, for example, an LED signage that flickers repeatedly at 500 Hz and the normal regions R302, R304, and R306 each show a moving subject have been photographed.

FIG. 3A shows an image (an impression) of the photographed image in the case where, in order to reduce the influence of flicker, both the flicker region R301 and the normal region R302 have been photographed with an exposure time t31 (= 1/500 sec) that is an integer multiple of a reciprocal of a flicker frequency. Photographing with this exposure time is capable of reducing the influence of flicker, but the subject moves during the exposure period, causing blurring of the subject within the normal region R302 as shown in FIG. 3A.

FIG. 3B shows an image (an impression) of the photographed image in the case where both the flicker region R301 and the normal region R302 have been photographed with a short exposure time t32 (= 1/2000 sec) so as to prevent blurring of the subject. When photographing is performed with this exposure time, as shown in FIG. 3B, no blurring occurs in the subject within the normal region R304, but since this exposure time is an exposure time shorter than the reciprocal of the flicker frequency, the image of the LED signage in the flicker region R303 is affected by flicker.

FIG. 3C shows an image (an impression) of the photographed image in the case where the flicker region R305 has been photographed with an exposure time t21 so as to reduce the influence of flicker, and the normal region R306 has been photographed with an exposure time t32 so as to prevent blurring of the subject. In this way, by photographing the flicker region R305 and the normal region R306 with different exposure times appropriate for the respective regions, as shown in FIG. 3C, no subject blurring occurs in the normal region R306, and it is possible to reduce the influence of flicker in the flicker region R305.

In the above description, the examples have been shown in which the flicker region has been treated as the characteristic region and the control of the exposure time has been performed with respect to the pixel unit 101, but the characteristic region and the control method for the pixel unit 101 are not limited to those in the above examples.

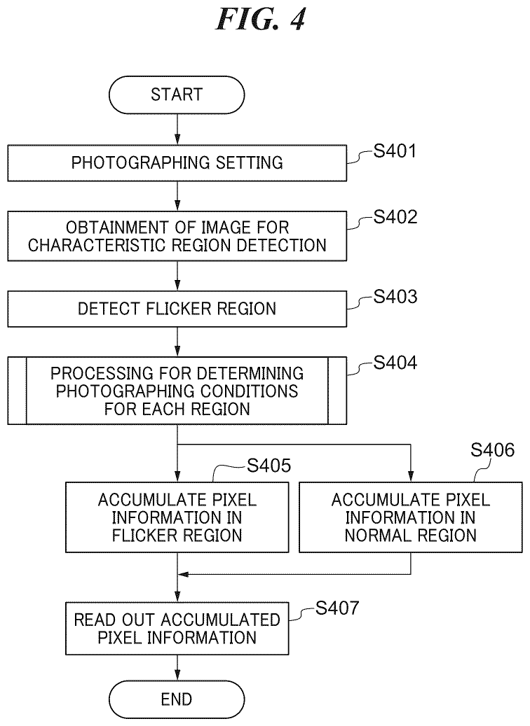

Next, the high-frequency flickerless photographing processing according to the first embodiment will be described with reference to a flowchart of FIG. 4.

As shown in FIG. 4, in a step S401, the system control unit 105 (a setting unit), with respect to the image pickup device unit 104, performs setting of photographing conditions in accordance with the user's instructions (first photographing conditions). The photographing conditions to be set here are, for example, an exposure time for the normal region (a first exposure time), the frame rate, etc., which have used values that have been set by the user using the operation unit 108.

In a step S402, upon detecting an instruction to start photographing (a photographing start instruction) from the user who is a photographer using the operation unit 108, the system control unit 105 issues an image pickup instruction to the image pickup device control unit 103. When the image pickup device control unit 103 receives this image pickup instruction, the image pickup device control unit 103 controls the pixel unit 101 and the characteristic region detecting unit 102 to obtain, from the pixel unit 101, pixel information for characteristic region detection. The pixel information for the characteristic region detection to be obtained here is not particularly limited, but examples thereof include a live view display image of the previous frame and a still image.

In a step S403, the system control unit 105 controls the characteristic region detecting unit 102 to detect a flicker region based on the pixel information for the characteristic region detection that has been obtained in the step S402. At this time, the characteristic region detecting unit 102 detects the flicker region by using, for example, a trained model that has been trained based on training data (teacher data). Specifically, the characteristic region detecting unit 102 detects an installation region of the signage from the shape of the signage identified based on edge information or the like by using the trained model, and determines that the detected installation region is a flicker region. However, the method for detecting a flicker region is not limited to the method described above. For example, it is possible to estimate a manner, in which flicker stripes occur, based on frequency information of general flicker, a readout speed of image data in the pixel unit 101, and the exposure time in the pixel unit 101. Therefore, a flicker region may be detected based on the estimation result, and the amount of a change in luminance within the image for the characteristic region detection that has been obtained in the step S402. Thereafter, the characteristic region detecting unit 102 transmits the detected flicker region to the image pickup device control unit 103.

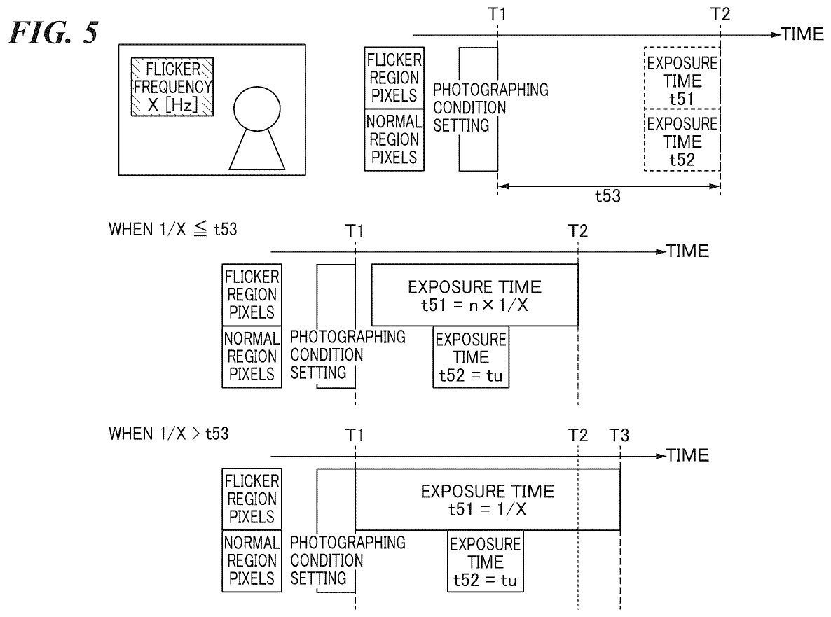

In a step S404, the system control unit 105 controls the image pickup device control unit 103 to execute a processing for determining photographing conditions for each region. In the processing for determining photographing conditions for each region, first, the image pickup device control unit 103 (a control unit) detects a flicker frequency (a characteristic quantity) in the flicker region that has been detected in the step S403. Then, the image pickup device control unit 103 determines photographing conditions for an exposure time setting (second photographing conditions) such as an accumulation time of the flicker region, an exposure start timing, and a readout timing based on the detected flicker frequency, and the photographing setting (the setting of the photographing conditions in accordance with the user's instructions) that has been performed in the step S401. The processing for determining photographing conditions for each region executed in the step S404 will be described in detail below with reference to FIG. 5.

In a step S405, the system control unit 105 controls the image pickup device control unit 103 to perform a photographing control of pixels in the flicker region detected in the step S403 in the pixel unit 101. By this photographing control, the image pickup device control unit 103 (the control unit) causes to photograph the pixels in the flicker region under the photographing conditions that have been determined in the step S404. After pixel information, which has been generated from the pixels in the flicker region, has been accumulated by performing the process of the step S405, the processing of FIG. 4 proceeds to a step S407.

In a step S406, the system control unit 105 controls the image pickup device control unit 103 to perform a photographing control of pixels in a normal region in the pixel unit 101. By this photographing control, the image pickup device control unit 103 (the control unit) causes to photograph the pixels in the normal region under the photographing conditions for the normal region that have been determined in the step S404. After pixel information, which has been generated from the pixels in the normal region, has been accumulated by performing the process of the step S406, the processing of FIG. 4 proceeds to the step S407.

In the step S407, the system control unit 105 controls the image pickup device control unit 103 to read out from the pixel unit 101 the pixel information that has been accumulated in the step S405 and the pixel information that has been accumulated in the step S406. The image pickup device control unit 103 outputs the pixel information read out from the pixel unit 101 to the system control unit 105 as image data for one image that has been photograph-controlled under the photographing conditions suitable for each of the flicker region and the normal region. The system control unit 105 performs image processing with respect to the image data that has been received from the image pickup device control unit 103, and performs recording in the recording unit 106 and displaying on the display unit 107. This image processing also includes generating moving image data, which uses the image data that has been received from the image pickup device control unit 103 as frame images. After that, the processing of FIG. 4 ends.

Next, the processing for determining photographing conditions for each region according to the first embodiment, performed by the image pickup device control unit 103, will be described with reference to FIG. 5. Here, an example is shown in which an LED signage with a flicker frequency of X Hz (a flicker frequency X Hz) is photographed. t51 represents an exposure time of the pixels in the flicker region (a second exposure time), and t52 represents an exposure time of the pixels in the normal region (the first exposure time). In addition, in the case of normal photographing in which an exposure time of all the pixels in the pixel unit 101 is a uniform exposure time (t51=t52), an exposure startable time is T1, a readout start time is T2, and a time from T1 to T2 (=an exposable time) is t53.

First, a reciprocal 1/X of the flicker frequency X Hz is compared with the exposable time t53. In the case where the reciprocal 1/X of the flicker frequency X Hz is equal to or less than the exposable time t53, the readout start time remains unchanged at T2, and the exposure time t51 of the flicker region is set to n×1/X (n is an integer). In this case, n is an integer n that minimizes the difference between n×1/X and t52 among integers n that do not exceed t53. At this time, the exposure time t52 of the normal region is set to, for example, an exposure time tu that has been set by the user in the step S401.

In the case where the reciprocal 1/X of the flicker frequency X Hz is longer than the exposable time t53, the exposure time t51 of the flicker region is set to 1/X, exposure of the flicker region is started from T1, which is the exposure startable time, and the readout start time is changed to T3, which is a time when the exposure of the flicker region ends. In the case of changing the readout start time from T2 to a time later than T2 in this way, for example, the system control unit 105 may control the image pickup apparatus 100 so as to lower the frame rate.

In addition, regarding the exposure start timing for the normal region and the exposure start timing for the flicker region, with respect to the pixel information of the normal region and the pixel information of the flicker region, in order to reduce a sense of incongruity, the exposure is controlled so as to align respective exposure centroids. Here, the exposure centroid means a median value of the time from the start of exposure to the end of exposure for all the pixels within each region.

As described above, in the first embodiment, a characteristic region is detected from the pixel unit 101, and different photographing controls are performed for the detected characteristic region and a region other than the detected characteristic region (=a normal region). As a result, even in a scene where the subject moves quickly, it is possible to photograph one image without blurring of the subject and with the influence of flicker that has been reduced.

In addition, the example of determining the photographing conditions for each region shown in FIG. 5 is one example in the first embodiment, and the method of determining the photographing conditions for each region is not limited to this example. For example, a configuration may be adopted in which the flicker frequency is detected in advance, and when setting the photographing conditions in the step S401, an exposure time tf of the flicker region is set in advance, and the exposure time t51 of the flicker region that has been detected in the step S403 is set as the exposure time tf.

In addition, in the example of determining the photographing conditions for each region shown in FIG. 5, a method of controlling the exposure time of the flicker region has been used, but the method is not limited to this method as long as it is a method capable of determining the photographing condition that is capable of reducing the influence of flicker. For example, a method may be used in which the influence of flicker is reduced by setting a photographing condition that performs accumulation a plurality of times only with respect to the flicker region, and obtaining an arithmetic average of a plurality of pieces of pixel information that have been obtained through the plurality of accumulations.

A second embodiment will be described. Next, determination of the photographing conditions for each region of the pixel unit 101 in the second embodiment will be described.

In the first embodiment, a method for determining the photographing conditions for each region when performing the flickerless photographing has been described, whereas in the second embodiment, a method for determining the photographing conditions for each region when performing high dynamic range photographing (HDR photographing) will be described.

It should be noted that in the second embodiment, the same hardware configurations as those in the first embodiment are denoted by the same reference numerals, and duplicate descriptions will be omitted.

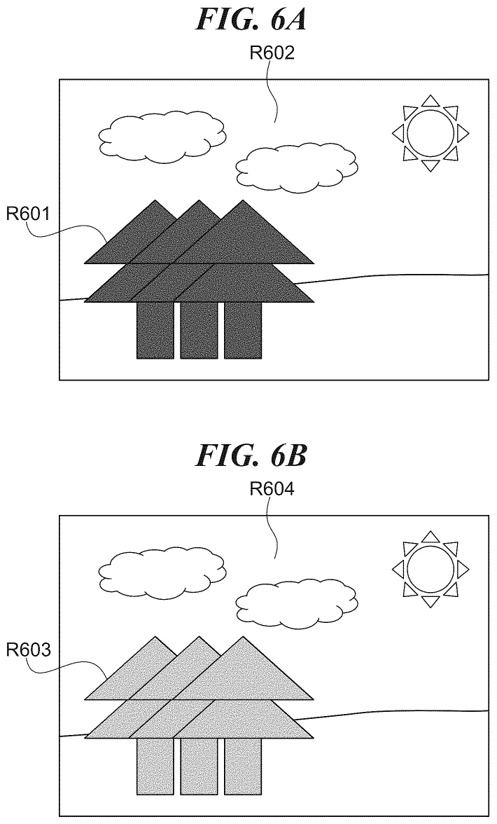

First, the HDR photographing will be described with reference to FIG. 6A and FIG. 6B.

Low luminance regions R601 and R603 represent regions with low luminance in respective photographed images that are shown in FIG. 6A and FIG. 6B, and normal regions R602 and R604 represent regions other than the low luminance regions in the respective photographed images that are shown in FIG. 6A and FIG. 6B. Hereinafter, the low luminance region will be described as the characteristic region.

FIG. 6A shows an image (an impression) of a scene photographed with a gain setting suitable for the normal region R602. For example, in a scene with strong sunlight as shown in FIG. 6A, a difference in brightness between the low luminance region R601 and the normal region R602 becomes large, and with the gain setting suitable for the normal region R602, the low luminance region R601 will become a blocked-up shadow. Conversely, with a gain setting suitable for the low luminance region R601, the normal region R602 will become a blown-out highlight.

FIG. 6B shows an image (an impression) of a scene photographed by only increasing a gain for the low luminance region R603 while leaving a gain for the normal region R604 unchanged compared to FIG. 6A.

In this way, by only increasing the gain for the low luminance region R603, the brightness of the low luminance region R603 is capable of being changed without changing the exposure conditions for the normal region R604. Therefore, it is possible to perform photographing under the exposure conditions suitable for both the low luminance region R603 and the normal region R604. In this case, if there is a time lag from the detection of the low luminance region to the gain control for each region, depending on the angle of view or the movement of the subject, there may be a discrepancy between the actual low luminance region and the region where the gain is increased, resulting in an increase in the gain for the normal region. Such an increase in the gain for the normal region causes an issue in that a part of the image becomes unnaturally bright. In the second embodiment, since the image pickup device unit 104 includes the characteristic region detecting unit 102 and the image pickup device control unit 103, so that the time lag from the detection to the photographing control is capable of being reduced, and therefore it is possible to prevent the part of the image from becoming unnaturally bright.

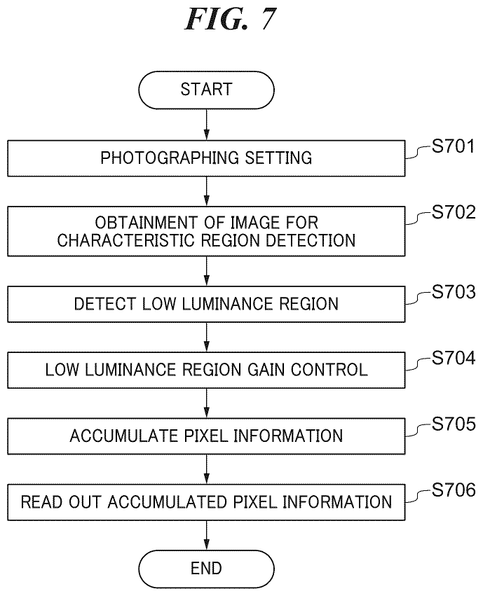

Next, an HDR photographing processing according to the second embodiment will be described with reference to a flowchart of FIG. 7.

As shown in FIG. 7, in a step S701, similar to the step S401, the system control unit 105, with respect to the image pickup device unit 104, performs setting of photographing conditions in accordance with the user's instructions. The photographing conditions to be set here are, for example, the gain setting for the normal region, etc., which have used values that have been set by the user using the operation unit 108.

In a step S702, similar to the step S402, upon detecting a photographing start instruction from the user who is the photographer using the operation unit 108, the system control unit 105 issues an image pickup instruction to the image pickup device control unit 103. When the image pickup device control unit 103 receives this image pickup instruction, the image pickup device control unit 103 controls the pixel unit 101 and the characteristic region detecting unit 102 to obtain, from the pixel unit 101, pixel information for characteristic region detection.

In a step S703, the system control unit 105 controls the characteristic region detecting unit 102 to calculate a luminance distribution (a characteristic quantity) based on the pixel information for the characteristic region detection that has been obtained in the step S702, and to detect a region with luminance lower than a threshold value as a low luminance region. Thereafter, the characteristic region detecting unit 102 transmits the detected low luminance region and the luminance distribution to the image pickup device control unit 103.

In a step S704, the system control unit 105 controls the image pickup device control unit 103 to execute a processing for determining photographing conditions for each region. In the processing for determining photographing conditions for each region, a gain is set with respect to the pixel unit 101 of the low luminance region that has been detected in the step S703. The gain to be set at this time is determined based on luminance information that has been detected in the step S703 so that a difference between a luminance average of the low luminance region and a luminance average of the normal region becomes within a threshold value.

In a step S705, the system control unit 105 controls the image pickup device control unit 103 to perform different photographing controls for the low luminance region and the normal region of the pixel unit 101. Through the photographing controls, the image pickup device control unit 103 controls the pixel unit 101 to accumulate optical signals, applies different gains to the regions that have been set in the step S701 and the step S704, converts them into electrical signals, and generates pixel information. With the pixel unit 101, the pixel information that has been generated by the photographing control is accumulated.

In a step S706, similar to the step S407, the system control unit 105 controls the image pickup device control unit 103 to read out from the pixel unit 101 the pixel information that has been accumulated in the step S705. The image pickup device control unit 103 outputs the pixel information read out from the pixel unit 101 to the system control unit 105 as image data for one image. The system control unit 105 performs image processing with respect to the image data that has been received from the image pickup device control unit 103, and performs recording in the recording unit 106 and displaying on the display unit 107. This image processing also includes generating moving image data, which uses the image data that has been received from the image pickup device control unit 103 as frame images. After that, the processing of FIG. 7 ends.

In this way, in the second embodiment, it is possible to realize the HDR photographing by photographing of one image.

It should be noted that the determination of the gain for each region shown in FIG. 7 is one example in the second embodiment, and is not limited to this method as long as the HDR photographing is possible. For example, a method for controlling exposure, such as the exposure time or ISO sensitivity setting, may be used.

A third embodiment will be described. Next, determination of the photographing conditions for each region of a pixel unit 101a in the third embodiment will be described.

In the first embodiment, the method for determining the photographing conditions for each region when performing the flickerless photographing has been described, and in the second embodiment, a method for determining the photographing conditions for each region when performing the HDR photographing has been described. On the other hand, in the third embodiment, a method for determining the photographing conditions for each region (a readout method setting) when performing autofocus control (AF control) will be described.

Here, in the first embodiment and the second embodiment, the pixel unit 101 has been used in which one photodiode is provided within one pixel. On the other hand, in the third embodiment, the pixel unit 101a is used in which a plurality of photodiodes capable of independently reading out pixel information are provided within one pixel.

Hereinafter, in the third embodiment, the same hardware configurations as those in the first embodiment are denoted by the same reference numerals, and duplicate descriptions will be omitted.

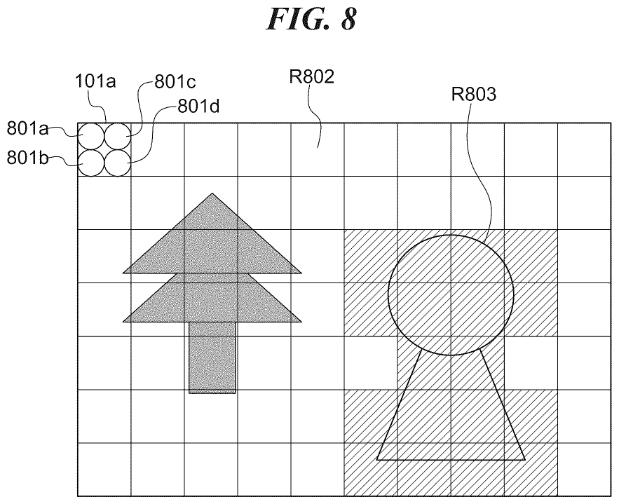

First, autofocus control (AF control) for each region using a plurality of photodiodes according to the third embodiment will be described with reference to FIG. 8. In the example shown in FIG. 8, each pixel constituting the pixel unit 101a is provided with four photodiodes 801a to 801d.

In the third embodiment, as an example of a method for calculating an in-focus position (an in-focus position calculation method), a distance calculation means (a distance calculation method) that compares phase differences of optical signals of a plurality of photodiodes within one pixel will be used for description. Here, image data to be obtained from the photodiodes 801a and 801b on the left side of each pixel is referred to as a left image, and image data to be obtained from the photodiodes 801c and 801d on the right side of each pixel is referred to as a right image. In the example of FIG. 8, each pixel of the pixel unit 101a has four photodiodes, but the third embodiment is not limited to this, and each pixel of the pixel unit 101a only needs to have two or more photodiodes.

A normal region R802 represents a region that does not include a subject that is an AF target, and a subject region R803 represents a region that includes the subject that is the AF target. Hereinafter, the subject region R803 will be described as the characteristic region.

The pixels indicated by diagonal lines in FIG. 8 represent pixels located in the subject region R803. In such a scene, the in-focus position calculation for focusing on the subject is performed by using the pixels indicated by the diagonal lines, and therefore pixels of the normal region R802 (pixels located in the normal region R802) are not required for the in-focus position calculation. Therefore, the right image and the left image of only the pixels located in the subject region R803 (the pixels of the subject region R803) are read out respectively, and are used for the in-focus position calculation. In this case, if there is a time lag from the detection of the subject region to the readout control, the movement of the subject will result in using the pixels of the region where there is no subject for the in-focus position calculation, which adversely affects the processing time and the accuracy of the in-focus position calculation. In the third embodiment, since it is possible to reduce the time lag from the detection of the subject region to the readout, even in a scene where the subject moves quickly, it is possible to accurately control the readout of the pixels of the subject region, and to reduce adverse effects on the processing time and the accuracy of the in-focus position calculation.

As a result, since the pixels not required for the in-focus position calculation are not read out separately for the left image and the right image, it is possible to reduce power consumption and speed up the processing time required for the in-focus position calculation.

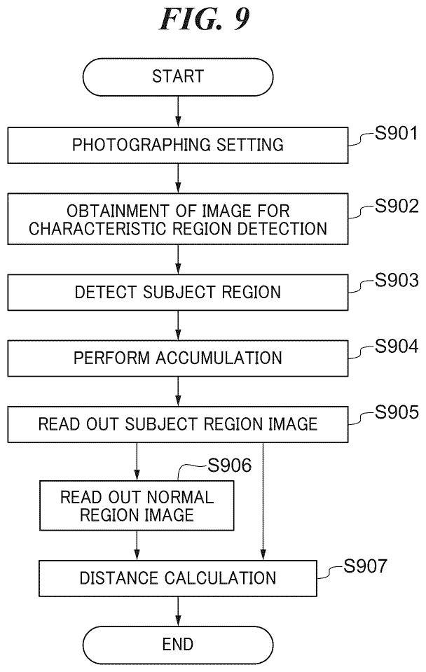

Next, an AF control processing according to the third embodiment will be described with reference to a flowchart of FIG. 9.

As shown in FIG. 9, in a step S901, similar to the step S401, the system control unit 105, with respect to the image pickup device unit 104, performs setting of photographing conditions in accordance with the user's instructions. In addition, the system control unit 105 obtains a user designation of a subject to be detected, such as “person”, from the operation unit 108.

In a step S902, similar to the step S402, upon detecting a photographing start instruction from the user who is the photographer using the operation unit 108, the system control unit 105 issues an image pickup instruction to the image pickup device control unit 103. When the image pickup device control unit 103 receives this image pickup instruction, the image pickup device control unit 103 controls the pixel unit 101a and the characteristic region detecting unit 102 to obtain, from the pixel unit 101a, pixel information for characteristic region detection.

In a step S903, the system control unit 105 controls the characteristic region detecting unit 102 to detect a subject region in the pixel unit 101a based on the pixel information for the characteristic region detection that has been obtained in the step S902. Specifically, the characteristic region detecting unit 102 detects a subject region in which a corresponding subject (for example, an object classified as “person”: a characteristic quantity) exists, based on a trained model that has been trained in advance based on training data (teacher data). The trained model here refers to a model that has been trained so as to classify object(s) that appear within each region from the characteristic region in the image, and in the case where a corresponding subject exists, the trained model outputs that area as the detection result. However, the method for detecting a subject region is not limited to the method described above. For example, the subject region R803 is designated in response to a touch operation by the user on a touch panel of the display unit 107 during live view display. However, as long as the subject region R803 is capable of being specified by some method, the method is not limited to the method of the third embodiment. For example, the subject region R803 may be designated in response to a user's drag operation of an AF frame displayed on the touch panel of the display unit 107.

In a step S904, the system control unit 105 controls the image pickup device control unit 103 to control the exposure of the pixel unit 101a based on the photographing conditions that have been set in the step S901, and the pixel unit 101a performs the accumulation of the right image and the left image at the respective pixels.

In a step S905, the system control unit 105 controls the image pickup device control unit 103 to independently read out the right image and the left image that have been accumulated in the step S904 from each pixel in the subject region that has been detected in the step S903, respectively. Thereafter, the image pickup device control unit 103 outputs, to the system control unit 105, the right image and the left image that have been read out from each pixel of the subject region as pixel information, respectively. After that, the processing of FIG. 9 proceeds to a step S907.

In a step S906, the system control unit 105 controls the image pickup device control unit 103 to perform additive composition of the right image and the left image that have been accumulated in the step S904 with respect to each pixel in a region outside the subject region of the pixel unit 101a (a normal region of the pixel unit 101a). Thereafter, the image pickup device control unit 103 reads out pixel information that has been obtained by the additive composition from each pixel of the normal region of the pixel unit 101a and outputs it to the system control unit 105. At this time, the pixel information that has been outputted in the step S906 is subjected to a development processing, etc., together with the pixel information that has been obtained in the step S905, and is used for purposes such as displaying on the display unit 107, but is not used for the in-focus position calculation. For this reason, depending on the photographing setting, the process of the step S906 may not be performed, for example, in the case of not displaying an image for the in-focus position calculation. After that, the processing of FIG. 9 proceeds to the step S907.

In the step S907, the system control unit 105 compares the phase difference between the right image and the left image that have been obtained in the step S905, performs the calculation of the in-focus position, and then ends the processing of FIG. 9.

As described above, in the third embodiment, the in-focus position calculation is performed only with respect to the subject region, and the in-focus position calculation is not performed with respect to the normal region. Therefore, it is possible to reduce the power consumption and speed up the processing time required for the in-focus position calculation.

The phase difference method has been used in the above-described in-focus position calculation, but this is just one example in the third embodiment, and the method for calculating the in-focus position is not limited to this method, and for example, a contrast method may be used.

A fourth embodiment will be described. Next, determination of the photographing conditions for each region of the pixel unit 101 in the fourth embodiment will be described.

In the third embodiment, the AF control has been described in which the subject region, which is a region that the user is paying attention to (hereinafter, referred to as “a region of interest”), is treated as the characteristic region. In the fourth embodiment, however, resolution-lowered photographing will be described in which a region of non-interest other than the subject region (the normal region) is treated as the characteristic region.

It should be noted that in the fourth embodiment, the same hardware configurations as those in the first embodiment are denoted by the same reference numerals, and duplicate descriptions will be omitted.

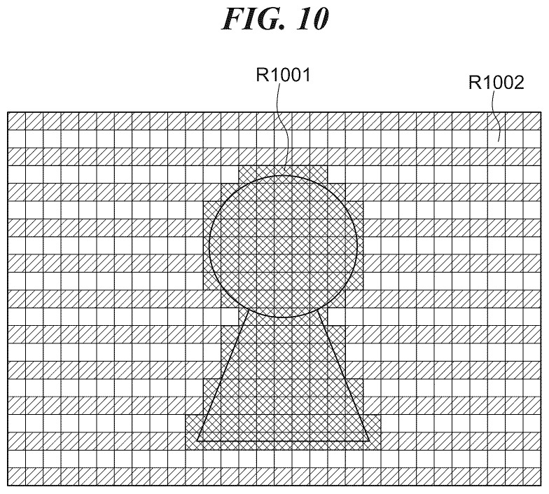

First, the resolution-lowered photographing of the region of non-interest according to the fourth embodiment will be described with reference to FIG. 10.

In fields such as virtual reality (VR), a method for performing reduction of processing by rendering a region of interest at a high resolution and rendering a region of non-interest at a lower resolution (at a lowered resolution) has been known.

Similarly, also in photographing of an image, for example, regarding an image for display, a high-resolution image is required for the subject region thereof that is important for determining the composition and confirming the focus, but by lowering the resolution in the normal region thereof, it is possible to reduce the amount of data and the power consumption. Therefore, only the subject region is read out at high resolution, and in the normal region, the resolution is lowered by performing thinning out and reading out, thereby being capable of reducing the amount of data and the power consumption.

In FIG. 10, a subject region R1001 represents a subject region that is to be rendered at high resolution, and a normal region R1002 represents a region other than the subject region R1001 that is to be rendered at a lower resolution (at a lowered resolution). In addition, the subject region R1001 is indicated by diagonal lines in FIG. 10.

Since the subject region R1001 is an important region when the user performs photographing, thinning out is not performed, and reading out of all pixels of the subject region R1001 is performed. On the other hand, in the normal region R1002, in order to reduce the amount of data and the power consumption, pixels of the normal region R1002 are read out while being thinned out. FIG. 10 shows an example in which only in the normal region R1002, the pixels thereof are thinned out to ½ and read out.

In the fourth embodiment, by changing a thinning-out rate depending on the region, it is possible to realize the resolution-lowered photographing of the region of non-interest. Hereinafter, the control of the resolution-lowered photographing of the region of non-interest according to the fourth embodiment will be described with reference to the flowchart of FIG. 9.

Since the steps S901 to S903 are the same as those described in the third embodiment, duplicate descriptions will be omitted. It should be noted that in the step S903, a region other than the detected subject region within the area of the pixel unit 101 is set to the normal region R1002 that has been described above.

In the step S904, the system control unit 105 controls the image pickup device control unit 103 to control the exposure of the pixel unit 101 based on the photographing conditions that have been set in the step S901. With the pixel unit 101, the pixel information that has been generated by the exposure control is accumulated.

In the step S905, the system control unit 105 controls the image pickup device control unit 103 to read out all pixel information accumulated at each pixel in the subject region that has been detected in the step S903. After that, the processing proceeds to the step S907.

In the step S906, the system control unit 105 controls the image pickup device control unit 103 to thin out the pixels of the normal region R1002 of the pixel unit 101 at a predetermined thinning-out rate (here, ½ in the vertical direction) and perform reading out of the pixel information. Thereafter, the system control unit 105 performs the development processing, etc., based on the pixel information that has been received from the image pickup device control unit 103. At this time, as an image for display, since it is necessary to adjust the size of the image (the image size), the subject region R1002 that has been read out in the step S905 is outputted as one image by arithmetic-averaging pixel information of two rows in the vertical direction and adjusting the image size. As a result, it is possible to obtain an image in which only the characteristic region has a high resolution. However, the adjustment of the image size is not limited to this method, and may be changed in accordance with the photographing setting and the photographing environment, such as adjusting the image size by linearly interpolating the thinned pixels in the region of non-interest R1001.

As described above, in the fourth embodiment, it is possible to perform photographing that achieves the reduction of the amount of data and power saving without lowering the resolution in the characteristic region.

The example shown in FIG. 10 is one example in the fourth embodiment, and the control of the readout method of the region of interest and the region of non-interest is not limited to this method.

It should be noted that although the first to fourth embodiments have been described separately, combinations of these embodiments may also be implemented.

For example, there may be a plurality of characteristic region detecting units 102, such as a characteristic region detecting unit 102a and a characteristic region detecting unit 102b, and each of the plurality of characteristic region detecting units 102 may detect a different characteristic region. As an example, the characteristic region detecting unit 102a detects a flicker region, and the characteristic region detecting unit 102b detects a subject region. The image pickup device control unit 103 controls the exposure time as shown in FIG. 3C, and performs the accumulation of the pixel information, based on the detection result of the flicker region. Thereafter, the image pickup device control unit 103 changes the thinning-out rate of the readout as shown in FIG. 10, based on the detection result of the subject region. As a result, it is possible to perform photographing that achieves the reduction of the amount of data without lowering the resolution in the subject region while reducing the influence of flicker. In this way, a plurality of regions may be detected simultaneously, and the photographing control may be performed by using a plurality of detection results.

In addition, the image pickup device unit 104 may include a detection target switching unit that switches to a target to be detected by the characteristic region detecting unit 102, and may switch to the target to be detected as a characteristic region. For example, the image pickup device unit 104 may include a storage unit that stores trained models used for the characteristic region detection, and may be configured to switch the detection target by switching the trained model used by the characteristic region detecting unit 102 depending on the photographing setting and the subject to be photographed.

It should be noted that in the above embodiments, the cases where the image pickup apparatus according to the present disclosure is a digital camera for personal use have been described, but the present disclosure is not limited to these cases. In other words, as long as it is equipped with an image pickup function and an image composition function and includes a user interface for setting the exposure time, for example, a mobile device, a smartphone, or a network camera that is connected to a server may be applied as the image pickup apparatus according to the present disclosure. In addition, part of the above-described processing may be performed by the mobile device, the smartphone, or the network camera that is connected to the server.

According to the present disclosure, it is possible to perform an optimal photographing control with respect to the pixels in each region of the image pickup device unit while suppressing the time lag until photographing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-173116, filed Oct. 2, 2024, which is hereby incorporated by reference herein in its entirety.

What is claimed is:

1. An image pickup apparatus comprising:
an image sensor configured to include a plurality of pixels; and
at least one processor or circuit and a memory storing instructions to cause the at least one processor or circuit to perform operations of the following units:
a setting unit that sets first photographing conditions in accordance with instructions from a user;
a detecting unit that detects a characteristic region based on pixel information obtained from the plurality of pixels; and
a control unit that causes pixels in the characteristic region among the plurality of pixels to be photographed under second photographing conditions different from the first photographing conditions, and causes pixels in another region other than the characteristic region among the plurality of pixels to be photographed under the first photographing conditions, and
wherein the detecting unit and the control unit are provided inside of the image sensor.

2. The image pickup apparatus according to claim 1, wherein
the second photographing conditions are different from the first photographing conditions in at least one photographing condition of an exposure time setting, a gain setting, and a readout method setting of the pixel information.

3. The image pickup apparatus according to claim 1, wherein
the control unit outputs, as image data for one image, pixel information from the pixels in the characteristic region, which has been obtained when photographing has been performed under the second photographing conditions, and pixel information from the pixels in the another region, which has been obtained when photographing has been performed under the first photographing conditions.

4. The image pickup apparatus according to claim 1, wherein
the control unit detects a characteristic quantity in the characteristic region and determines the second photographing conditions in accordance with the characteristic quantity.

5. The image pickup apparatus according to claim 4, wherein
the first photographing conditions include a first exposure time for the pixels in the another region,
the second photographing conditions include a second exposure time for the pixels in the characteristic region, which is different from the first exposure time, and
the control unit determines the second exposure time in accordance with the first photographing conditions and the characteristic quantity.

6. The image pickup apparatus according to claim 5, wherein
the control unit controls an exposure start timing and a readout timing so as to align exposure centroids of the first exposure time and the second exposure time.

7. The image pickup apparatus according to claim 1, wherein
each of the plurality of pixels includes two or more photodiodes that are capable of independently reading out pixel information.

8. The image pickup apparatus according to claim 7, wherein
the control unit independently reads out pixel information from each of the two or more photodiodes from the pixels in the characteristic region, and performs an in-focus position calculation based on a phase difference between the independently-read-out pixel information.

9. The image pickup apparatus according to claim 2, wherein
the control unit thins out pixel information from the pixels in the characteristic region at a predetermined thinning-out rate and reads out it.

10. The image pickup apparatus according to claim 1, wherein
the detecting unit is also provided outside of the image sensor, and
the image pickup apparatus further comprises a switching unit for switching to the detecting unit to be used among the detecting units that are provided the inside and the outside of the image sensor.

11. The image pickup apparatus according to claim 1, wherein
the image sensor further comprises a detection target switching unit for switching to a target to be detected as the characteristic region by the detecting unit.

12. A control method for an image pickup apparatus that comprises an image sensor configured to include a plurality of pixels and a setting unit configured to set first photographing conditions in accordance with instructions from a user, the control method comprising:
a detecting step, executed in the image sensor, of detecting a characteristic region based on pixel information obtained from the plurality of pixels; and
a control step, executed in the image sensor, of causing pixels in the characteristic region among the plurality of pixels to be photographed under second photographing conditions different from the first photographing conditions, and causing pixels in another region other than the characteristic region among the plurality of pixels to be photographed under the first photographing conditions.

13. A non-transitory computer-readable storage medium storing a program for causing a computer to execute a control method for an image pickup apparatus that comprises an image sensor configured to include a plurality of pixels and a setting unit configured to set first photographing conditions in accordance with instructions from a user, the control method comprising:
a detecting step, executed in the image sensor, of detecting a characteristic region based on pixel information obtained from the plurality of pixels; and
a control step, executed in the image sensor, of causing pixels in the characteristic region among the plurality of pixels to be photographed under second photographing conditions different from the first photographing conditions, and causing pixels in another region other than the characteristic region among the plurality of pixels to be photographed under the first photographing conditions.
